(19) United States
(12) Patent Application Publication
(10) Pub. No.: US 2007/0071131 A1
(43) Pub. Date: Mar. 29, 2007

(54) Switched phase receiver for a long range RFID system

(76) Inventors: John W. Pyne, Erie, CO (US); Gary L. Overhultz, River Forest, IL (US)

Correspondence Address: Joseph M. Sauer;Jones Day, North Point, 901 Lakeside Avenue, Cleveland, OH, 44114, US

(21) Appl. No.: 11/590,054

(22) Filed: Oct. 31, 2006

Related U.S. Application Data
(63) Continuation-in-part of application No. 11/281,283, filed on Nov. 17, 2005.
(63) Continuation-in-part of application No. 11/281,859, filed on Nov. 17, 2005.
(60) Provisional application No. 60/629,496, filed on Nov. 19, 2004.
(60) Provisional application No. 60/629,216, filed on Nov. 18, 2004.

(51) Int. Cl. H04B 1/16; H04L 25/06

(52) U.S. Cl. 375/319; 455/205

(57) ABSTRACT

A conversion receiver in a radio frequency identification system includes a phase shifting circuit that shifts the phase of a received signal. A switching circuit is coupled to the phase shifting circuit and selects either the received signal, or the phase shifted signal. A single receiver chain is coupled to the switching circuit and is configured to process either the received signal or the phase shifted received signal.

### BACKGROUND

1. Field

The technology described herein relates to Radio Frequency Identification (RFID) systems.

2. Related Art

RFID systems commonly use backscatter modulation to convey a tag ID to a reader. Most RFID readers directly down convert the RF signal leaving the sub carrier to be further processed to extract the RFID tag data. The direct down conversion is an efficient and cost effective way of receiving the data but is subject to phase ambiguities that cancel weak tag signals.

The traditional approach to solve these ambiguities is to process the received data through a quadrature hybrid. Phase ambiguity is overcome by receiving both outputs from the quadrature hybrid and reporting the union of the two sets of tag IDs. If one of the outputs falls into the phase ambiguity angle and is cancelled, then the other output receives the signal.

The phase ambiguity places design requirements on the receiver. A common approach is shown in FIG. 1. FIG. 1 shows a receiver 20 having two paths 26 and 28. A signal 22 is received into a quadrature hybrid 24, and is split into two signals, I and Q. The I signal is the received signal 22 with no phase shift, where the Q signal is the received signal 22 phase shifted by 90 degrees. The first receiver chain 26 processes the in-phase signal I, and the second receiver chain 28 processes the quadrative-phase signal Q. The Received Signal Strength Indicators (RSSI) of both signals I, and Q, is fed into an analog/digital converter 62. A microcontroller 64 receives the signal generated from the analog/digital converter 62, and also receives the signals processed through the first receiver chain 26 and the second receiver chain 28. Data 66 is transmitted to a receiver elsewhere.

RFID systems operating in more static environments may get many attempts to read a tag and use statistical inferences to detect the presence or absence of an item. These systems may not require the added complexity of simultaneously processing the two quadrature hybrid channels.

### SUMMARY

A conversion receiver in a radio frequency identification system is provided. A phase shifting circuit may be used to shift the phase of a received signal. A switching circuit may be coupled to the phase shifting circuit and may select either the received signal or the phase shifted received signal. A single receiver chain may be coupled to the switching circuit and can be configured to process either the received signal or the phase shifted received signal.

### BRIEF DESCRIPTION OF THE DRAWINGS

FIG. 1 is a block diagram of a typical I/Q direct conversion receiver.

FIG. 2 is a block diagram of an embodiment of a switched I/Q receiver.

FIG. 3 is a block diagram of another embodiment of a switched I/Q receiver.

FIG. 4 is a flowchart of a method for transmission of a signal from a switched I/Q receiver.

### DETAILED DESCRIPTION OF THE DRAWINGS

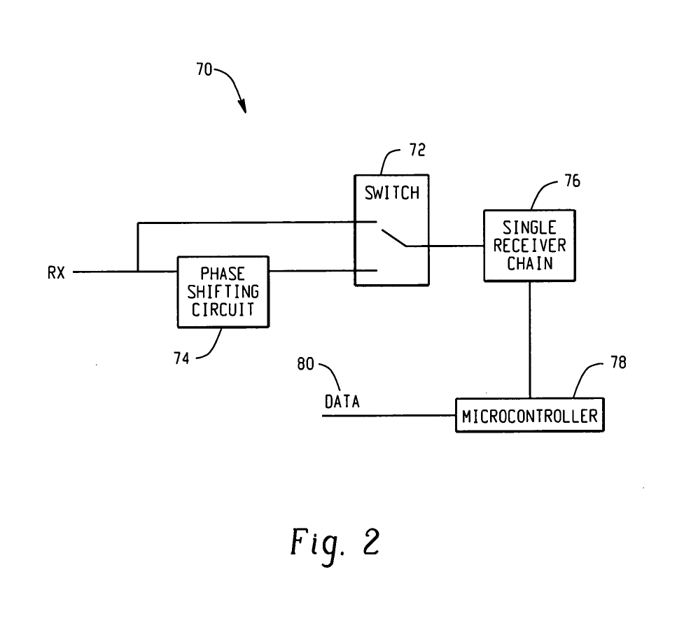

FIG. 2 is a block diagram of an example of a switched I/Q receiver 70. The switched I/Q receiver 70 includes a phase shifting circuit 74, a switch 72, a single receiver chain 76 and a microcontroller 78. The phase shifting circuit 74 receives a received signal and generates a phase shifted signal.

The switch 72 receives both the received signal and the phase shifted signal generated by the phase shifting circuit 74. The switch 74 can switch between the received signal and the phase shifted signal, and provides one of those two signals to the receiver chain 76. The single receiver chain 76 receives the selected signal from the switch 74 (either the received signal or the phase-shifted signal), and processes that signal. The signal may, for example, be processed by down-converting, amplifying and filtering the signal.

The signal processed by the single receiver chain 76 is received by the microcontroller 78. The microcontroller 78 analyzes the signal and determines the data 80 to be transmitted. The data 80 may, for example, include information on RFID tags that were detected, the Received Signal Strength Indicator of the signal processed by the single receiver chain 76, or the position of the switch 72, indicating whether the in-phase or phase-shifted signal was processed. The microcontroller 78 may, for example, be able to generate the data 80 which will be transmitted remotely where the data 80 can be monitored.

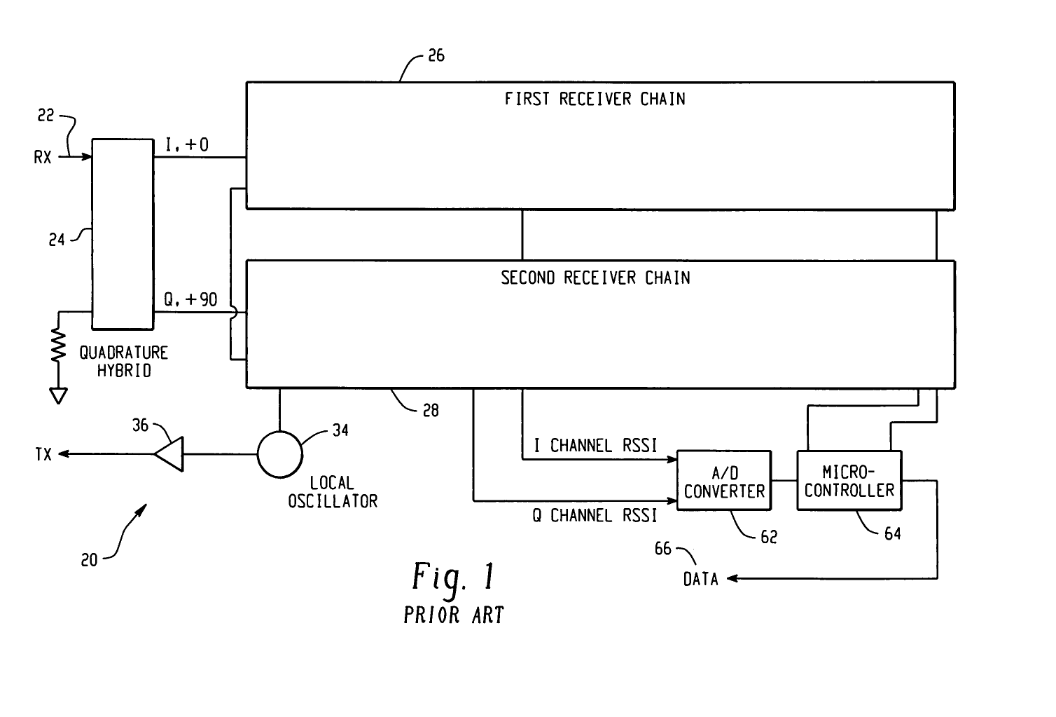

Because the I/Q receiver 70 illustrated in FIG. 2 only requires a single receiver chain 76, it can be implemented using less resources than the typical I/Q receiver 70 shown in FIG. 1. In certain systems, this advantage may outweigh the benefits provided by simultaneously processing the I and Q signals. For example, if changes to the received signal do not need to be immediately detected, parallel I and Q receiver chains may be unnecessary. The I/Q receiver 70 shown in FIG. 2 may, for example, be particularly beneficial in the RFID system described in detail in U.S. patent application Ser. No. 10/665,540 which is incorporated by reference.

A specific situation where the I/Q receiver 70 shown in FIG. 2 may be particularly useful is a system for monitoring stocked items in a retail environment. Signals received from RFID tags on stocked items may change infrequently. In such a system, the receiver in FIG. 2 has adequate performance for detecting all of the tags without the added resources of simultaneously processing the I and Q signals. Alternating between processing the I and Q signals will ensure that all RFID tags are detected despite any potential phase ambiguity.

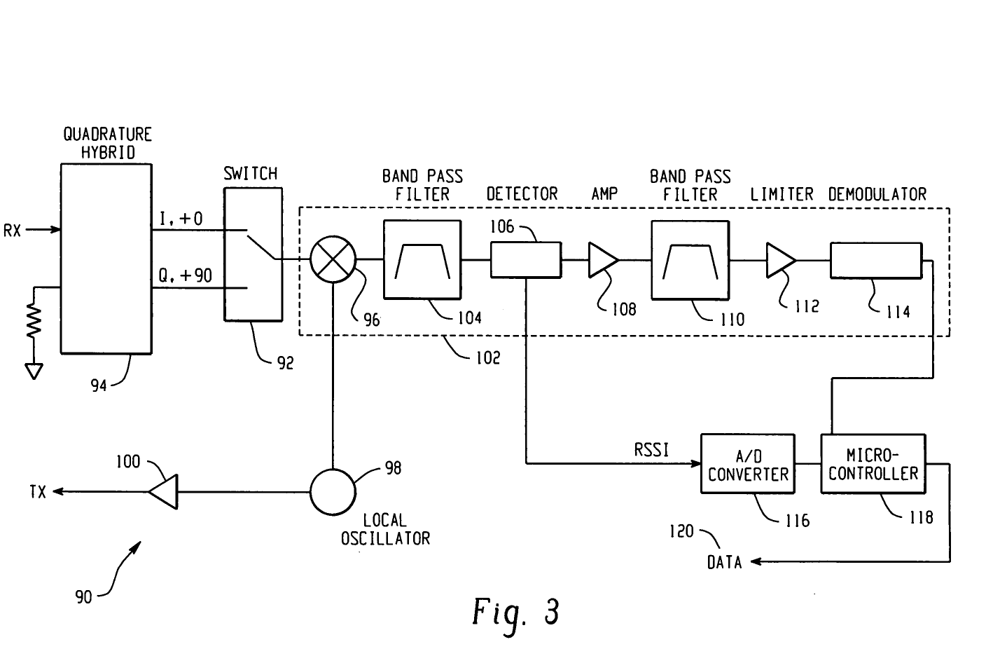

FIG. 3 is a more detailed block diagram of an embodiment of a switched I/Q receiver 90. The received signal is input into one input terminal of a quadrature hybrid 94. The quadrature hybrid 94 is a type of phase shifting circuit that has four terminals—two inputs and two outputs. The received signal can be processed through one of the inputs, and the other input can be terminated with a load impedance. The quadrature hybrid 94 splits the received signal into two outputs. One of the outputs is the received signal with no phase shift, and the second output is the received signal with a phase shift of 90 degrees.

The first output of the quadrature hybrid 94, I, is not phase shifted, and the second output of the quadrature hybrid 94, Q, is phase shifted. Both of these signals are input into a switch 92. Depending on the position of the switch, one of the two signals, I or Q, is selected by the switch 92, and input into a single receiver chain 102. Because only one signal is processed at a time, a second receiver path is unnecessary. The receiver path 102 can process the signal selected by the switch 92, and may include a mixer 96, a band pass filter 104, a detector 106, an amplifier 108, a second band pass filter 110, a limiter 112 and a demodulator 114.

In an exemplary embodiment, the system may be programmed to wake up at a certain time interval. When the system wakes up, the RF signal is read, and the switch 92 is set to either the I position or the Q position to process one of the outputs of the quadrature hybrid 94. The switched signal is processed through the receiver path 102. The RSSI is detected and passed through an Analog to Digital converter 116 and into a microcontroller 118. The microcontroller 118 generates data 120 to be transmitted, including the tag reads, RSSI and the position of the I/Q switch 92. The data 120 is transmitted over the signal generated by the local oscillator 98 and amplifier 100.

When the system wakes up a second time, a similar read is made, except the switch 92 is toggled to the alternate position from where it was during the first read. The signal is then processed in the same fashion as above. With a relatively static system, any tags that might have been missed during the first read will be captured during the second read when the phase is toggled.

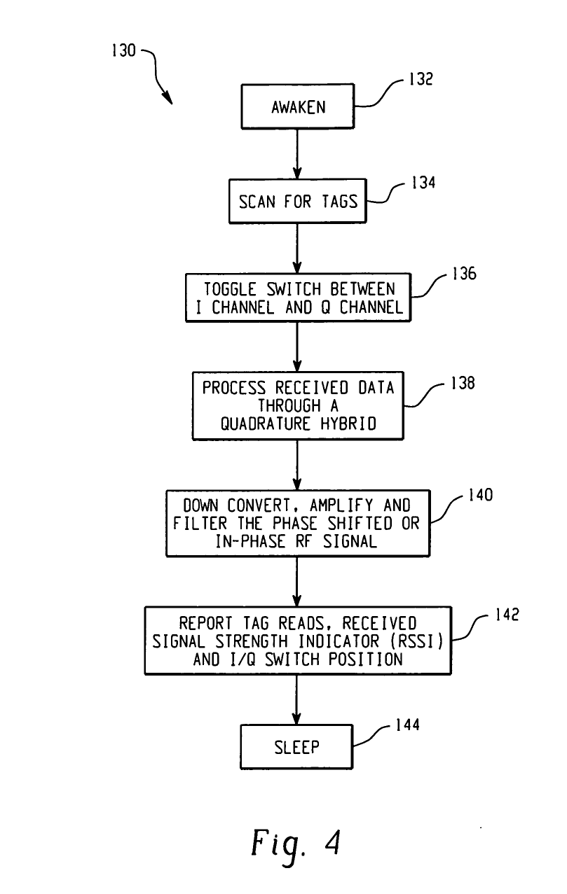

FIG. 4 is a flowchart 130 of a method for transmission of a signal from a switched I/Q receiver. The method begins at step 132 when the system awakens from a sleep state. At step 134, the system begins to scan for tags present. Next, the I/Q switch is toggled between the I channel and the Q channel in step 136. If the switch was previously in the I channel position, it is switched to the Q channel position, and if it was previously in the Q channel position, then it is switched to the I channel position. This ensures that each time the system awakens, and the tags are read, the position of the switch is alternated.

In step 138, the received data is processed through the quadrature hybrid, and is output either as an in phase output, or as a 90 degree shifted phase output, according to the position that the switch was placed in step 136. In step 140, that signal is down-converted, amplified and filtered. Next, in step 142, the tag reads, Received Signal Strength Indicator (RSSI) and I/Q switch position are reported. Finally at step 144, the system returns to sleep. When it awakens a second time, the method is repeated with the I/Q switch toggled to the opposite position.

This written description uses examples to disclose the invention, including the best mode, and also to enable a person skilled in the art to make and use the invention. The patentable scope of the invention may include other examples that occur to those skilled in the art.

It is claimed:

1. A conversion receiver in a radio frequency identification system, the conversion receiver comprising:
a phase shifting circuit to phase shift a received signal;
a switching circuit coupled to the phase shifting circuit to select either the received signal or the phase shifted received signal;
a single receiver chain coupled to the switching circuit configured to process either the received signal or the phase shifted received signal.

2. The conversion receiver of claim 1, wherein the phase shifting circuit is a quadrature hybrid, and the phase shifted received signal is phase shifted 90 degrees.

3. The conversion receiver of claim 1, wherein the single receiver chain comprises:
a bandpass filter;
a detector; and
a demodulator.

4. The conversion receiver of claim 1, wherein the received signal comprised product ID tags.

5. The conversion receiver of claim 1 further comprising a microcontroller.

6. The conversion receiver of claim 5, wherein the microcontroller generates data for transmission.

7. The conversion receiver of claim 6, wherein the data includes ID tag reads, the position of the shifting circuit, and the Received Signal Strength Indicator of the received signal.

8. The conversion receiver of claim 7, further comprising an antenna for transmission of the data.

9. A method of transmitting data to minimize RFID backscatter modulation by a transmission antenna array, the method comprising:
receiving a radio frequency signal;
shifting the phase of the radio frequency signal; and
processing either the received radio frequency signal or the phase shifted radio frequency signal, the processing occurring in a single receiver chain.

10. The method of claim 9, wherein the shifting step is performed by a quadrature hybrid, and the radio frequency signal is phase shifted 90 degrees.

11. The method of claim 9, wherein the processing step comprises:
down-converting the received radio frequency signal or the phase shifted radio frequency signal;
amplifying the received radio frequency signal or the phase shifted radio frequency signal; and
filtering the received radio frequency signal or the phase shifted radio frequency signal.

12. The method of claim 9, wherein the received radio frequency signal comprises product ID tag information.

13. The method of claim 9, further comprising the step of generating data from the processed received radio frequency signal or the phase shifted radio frequency signal for transmission.

14. The method of claim 13, wherein the generated data comprises product ID tag reads, an indicator as to whether the received radio frequency signal or the phase shifted radio frequency signal was processed, and the Received Signal Strength Indicator of the processed signal.

15. The method of claim 14 further comprising transmitting the generated data.

16. The method of claim 15, further including the step of sleeping after transmitting the generated data.

17. The method of claim 16, further including the step of awakening prior to receiving a radio frequency signal.

18. The method of claim 17, wherein the step of sleeping comprises sleeping for a pre-determined period of time.

19. The method of claim 17, wherein the receiving step includes receiving a single radio frequency signal.
